(19) United States
(12) Patent Application Publication
(10) Pub. No.: US 2015/0165475 A1
(43) Pub. Date: Jun. 18, 2015

(54) PROCESS BOX, ASSEMBLY, AND METHOD FOR PROCESSING A COATED SUBSTRATE

(71) Applicant: Saint-Gobain Glass France, Courbevoie (FR)

(72) Inventors: Jörg Palm, Munchen (DE); Martin Fürfanger, Steinhoring (DE); Stefan Jost, Munchen (DE)

(21) Appl. No.: 14/413,569

(22) PCT Filed: Jul. 9, 2013
(86) PCT No.: PCT/EP2013/064516

§ 371 Date: Jan. 8, 2015

(30) Foreign Application Priority Data
Jul. 9, 2012 (EP) 12175596.1

(51) Int. Cl. B05D 1/00; B05C 5/00

(52) U.S. Cl. CPC B05D 1/60; B05C 5/001

(57) ABSTRACT

The present invention relates to a process box for processing a coated substrate, with the following features: a gas-tightly sealable housing, which forms a hollow space; the housing comprises at least one housing section, which is implemented such that the substrate is heat treatable by electromagnetic thermal radiation incident on the housing section; the housing has at least one housing section coupleable to a cooling device for its cooling and at least one non-coolable housing section; the hollow space is divided by at least one separating wall into a process space for accommodating the substrate and an intermediate space, wherein the separating wall has one or a plurality of openings and is arranged between the substrate and the temperature-controlable housing section; the housing is provided with at least one sealable gas passage that opens into the hollow space, for evacuating and introducing process gas into the hollow space. The invention further relates to assemblies and a method for processing a coated substrate, in which method at least one housing section of the process box is cooled during and/or after the heat treatment and diffusion to the temperature-controlled housing section of a gaseous substance generated during the heat treatment is inhibited by a separating wall provided with one or a plurality of openings, which is arranged between the coated substrate and the temperature-controlled housing section.

The invention relates to a process box, an assembly, and a method for processing a coated substrate. It relates in particular to the processing of a substrate, which is coated with precursor layers for producing an absorber made of a compound semiconductor for thin-film solar cells.

Photovoltaic layer systems for the direct conversion of sunlight into electrical energy are well known. They are commonly referred to as “solar cells”, with the term “thin-film solar cells” referring to layer systems with small thicknesses of only a few microns that require substrates for adequate mechanical stability. Known substrates include inorganic glass, plastics (polymers), or metals, in particular, metal alloys, and can, depending on the respective layer thickness and the specific material properties, be designed as rigid plates or flexible films.

In view of the technological handling quality and efficiency, thin-film solar cells with absorbers made of compound semiconductors have proved advantageous. In the patent literature, thin-film solar cells have already been described frequently. Reference is made merely by way of example to the printed publications DE 4324318 C1 and EP 2200097 A1.

Mainly used as absorbers in thin-film solar cells are compound semiconductors made of chalcopyrite compounds, in particular, copper-indium/gallium-disulfur/diselenide, abbreviated as Cu(In,Ga) (S,Se)₂, or kesterite compounds, in particular, copper-zinc/tin-disulfur/diselenide, abbreviated as Cu₂(Zn,Sn)(S,Se)₄. Of the various possibilities for producing the compound semiconductor, essentially two methods have prevailed in recent years. This is vapor co-deposition of the individual elements onto a hot substrate as well as the successive application of the elements in individual layers (precursor layers) onto a cold substrate, for example, by sputtering, combined with rapid thermal processing (RTP), during which the actual crystal formation and phase conversion of the precursor layers into the compound semiconductors occurs. This last two-stage approach is described in detail, for example, in J. Palm et al., “CIS module pilot processing applying concurrent rapid selenization and sulfurization of large area thin film precursors”, Thin Solid Films 431-432, pp. 414-522 (2003).

In the industrial-scale production of thin-film solar modules, the RTP thermal processing of precursor layers occurs in in-line systems, in which the coated substrates are transported sequentially into various process chambers. Such a method is known, for example, from EP 0662247 B1.

The RTP-thermal processing of precursor layers is a complex process that requires rapid heating rates in the range of a few K/s, a homogeneous temperature distribution over the substrate (laterally) and over the substrate thickness, maximum temperatures above 500° C., as well as precise control of the process atmosphere. In particular, during the production of a chalcopyrite compound, an adequately high, controllable, and reproducible partial pressure of the readily volatile chalcogen elements applied, for example, to the substrate (Se and/or S), and a controlled process gas delivery (e.g., H₂, N₂, Ar, H₂S, H₂Se, S-gas, Se-gas) must be ensured. For example, in-line selinization of a metal CuInGa-precursor layer stack requires an adequate Se quantity for complete selinization. A significant Se loss results in incomplete conversion of the precursor layers to the chalcopyrite compound and even a slight Se loss results in impaired performance of the finished thin-film solar module.

It is known to limit the process space around the coated substrate by means of a process box. The process box enables keeping the partial pressure of readily volatile chalkogen components, such as selenium or sulfur, at least largely constant during the heat treatment. Moreover, the exposure of the process chamber to corrosive gases is reduced. Such a process box is known, for example, from DE 102008022784 A1.

In the in-line systems used for industrial-scale production of thin-film solar modules, the coated substrates or the process boxes loaded therewith pass through various process chambers in index operation, wherein they are transported in cycles to the respective next process chamber. The process chambers are generally designed as gas-tightly sealable (evacuable) chambers since the entire process path must be pumped out or evacuated for removal of oxygen and water. Even though processing of the substrates is usually done at normal pressure (or a slightly negative pressure, for safety reasons), gas tightness of the process chambers is required to prevent the inward diffusion of oxygen and water into the process line and the outflow of toxic gases. Only an intake and outlet lock are periodically pumped out.

In general, the construction of evacuable process chambers is complex and technically demanding since the necessary vacuum tightness makes extremely high demands on materials used in system components such as vacuum feedthroughs, in particular rotary feedthroughs, valves, transport rollers, gas docking stations, cooling plates, and vacuum seals. For this reason, the investment costs for this process step account for a not insubstantial share in the overall investment costs of a solar factory. In addition, it has been shown in practice that the technically complex and relatively expensive components, which are designed for vacuum tightness of the process chambers, are subject to significantly increased wear from the transport of the coated substrates or process boxes, the heating to high maximum temperatures of more than 500° C., as well as the corrosive process atmosphere and can become leaky. In the event of a failure, the complete production chain is interrupted by the necessary maintenance work.

US Patent Application No. 2005/0238476 A1 discloses an apparatus for transporting a substrate in a controlled atmosphere with a housing that includes an evacuable substrate space for the substrate and a secondary space. The substrate space and the secondary space are separated from each other by a separating wall with nanopores, wherein the separating wall forms a micropump based on the Knudsen principle (thermal osmosis). The substrate space has a cooling plate (decontamination plate), wherein the separating wall is arranged not between the substrate and the cooling plate. Instead, the cooling plate is always arranged in a position opposite the substrate. In addition, the secondary space is thermally decoupled from the housing section or substrate space cooled by the cooling plate by the heatable separating wall. Heating is necessary for the pumping mechanism.

In contrast, the object of the present invention is to provide a capability of subjecting coated substrates to heat treatment in a technically significantly simpler and more economical system. This and other objects are accomplished according to the proposal of the invention by means of a process box, an assembly, and a method for processing a coated substrate in accordance with the coordinated claims. Preferred embodiments of the invention emerge from the characteristics of the subclaims.

According to the invention, a process box for processing a coated substrate is presented, which can be used as either a transportable or a stationary process box.

In the context of invention, the term “substrate” refers to a flat object that has two surfaces placed opposite each other, wherein a layer structure including a plurality of layers is typically applied on one of the two surfaces. The other surface of the substrate is usually not coated. For example, it is a substrate for production of a thin-film solar module coated with precursor layers of a compound semiconductor (e.g., a chalkopyrite or kesterite compound) that must be subjected to RTP-thermal processing.

The process box according to the invention comprises a housing, by which a gas-tightly sealable (evacuable) hollow space is formed or enclosed. The clear height of the hollow space is preferably dimensioned such that gases can be pumped out in the shortest possible time and the high demands with regard to oxygen content and partial water pressure during RTP thermal processing can be met. The housing can, in principle, be made from any material suitable for the intended use, for example, metal, glass, ceramic, glass ceramic, carbon fiber reinforced carbon materials, or graphite.

It is essential here that the housing of the process box have one or plurality of housing sections, which are in each case implemented to enable heat treatment by means of electromagnetic thermal radiation incident on the housing section. The housing sections serving for heat treatment can be, for this purpose, transparent, partially transparent, or opaque to electromagnetic thermal radiation for processing the substrate. For example, the housing sections serving for heat treatment are made of glass ceramic. The housing sections serving for heat treatment can, in particular, even contain a material (e.g., graphite) or be made of a material that is suitable to at least partially, in particular, completely, absorb the electromagnetic thermal radiation of radiant heaters in order to be heated themselves. The heated housing section can then serve as a secondary heat source for heating the substrate, which can, in particular, result in homogenization of the heat distribution.

The housing of the process box further includes one or a plurality of temperature-controllable or actively coolable (first) housing sections, whose temperature can be set to a pre-definable temperature value. The housing sections are, for this purpose, thermotechnically coupleable or coupled in each case to an (external) temperature-controlling or cooling device.

The first housing sections are, for example, (fluidically) connected or connectable to the cooling device and, consequently, be cooled, whereas, in contrast, the second housing sections are not connected to the cooling device and, consequently, cannot be cooled. Moreover, the housing includes one or plurality of non-temperature-controllable or coolable, i.e., not coupleable or coupled to the temperature controlling or cooling device, (second) housing sections, which are, in particular, those housing sections that enable heat treatment by means of electromagnetic thermal radiation incident on the housing section, in other words, lie in the radiation field of the radiant heaters. The first housing sections are different from the second housing sections.

The temperature-controlable or coolable (first) housing sections are actively coolable, in comparison with the temperature of the substrate and of those housing sections, that enable heat treatment by incident electromagnetic thermal radiation, and are situated in the radiation field of the radiant heaters. The temperature-controlable or coolable housing sections of the process box can be temperature controlled or actively cooled before, during, and/or after a heat treatment of the coated substrate.

As used here and in the following, the term “coolable” refers to temperature controlling (cooling) of the housing section to a temperature that is lower than the temperature of the substrate during heat treatment or, to those housing sections that enable heat treatment by incident electromagnetic thermal radiation and lie in the radiation field of the radiant heaters. For example, the housing section is temperature controlled to a temperature in the range from 20° C. to 200° C. Because of this temperature control (cooling), the plastic seals customary in vacuum technology (elastomers, fluoroelastomers) and other comparatively economical standard components can be used for the vacuum sealing of the process box, which, however, do not withstand temperatures above 200° C. long-term.

Moreover, the housing of the process box includes at least one gas passage that opens into the hollow space sealable (for example, by means of a valve) for evacuating the hollow space and introduction of process gas into the hollow space. The gas passage can open, for this purpose, in particular into the intermediate space. The process gas can, for example, contain reactive gases such as H₂S, H₂Se, S vapor, Se vapor, or H₂ as well as inert gases such as N₂, He, or Ar.

In the process box according to the invention, the hollow space formed by the housing is divided by at least one separating wall into a process space for accommodating the coated substrate and an intermediate space, wherein the separating wall is arranged between the coated substrate and the (first) housing section that is actively cooled, i.e., coupleable or coupled to the cooling device. The process space is enclosed exclusively by the at least one separating wall and one or a plurality of (second) housing sections of the process box that are not temperature-controlable, i.e., not coupled to the cooling device.

Is essential that the separating wall serves as a diffusion barrier (vapor barrier) for a gas exchange between the process space and the intermediate space during the heat treatment, but enables a gas exchange between the process space and the intermediate space, at least temporarily, before and after the heat treatment such that pumping out of gaseous substances from the process space as well as filling with a process gas through the separating wall is possible. The separating wall has, for this purpose, one or a plurality of openings or breaks, through which the process space and the intermediate space are fluidically connected to each other. Generally speaking, the openings can have any shape, for example, a slot shape or a round hole shape, and can even be arranged on the periphery.

In one advantageous embodiment, the separating wall does not reach all the way to a housing wall such that an opening, in particular, a gap, remains between the separating wall and the housing wall.

In particular, the separating wall can be made of a porous material or a material provided with tubes (straight, oblique, or angled tubes) or include such a material.

For example, but not absolutely necessarily, one smallest dimension, for example, a radius or diameter of a respective opening of the separating wall is greater than the length of the mean free path of the gas particles in the process space.

Generally speaking, a process space for processing the coated substrate is formed by the separating wall, which process space is separated quasi-gas-tightly from the intermediate space by the separating wall. In contrast to an open process space, which permits a free gas exchange between the process space and the external surroundings, as well as to a gas-tight process space, in which such a gas exchange between the process space and the external surroundings is completely suppressed, the gas exchange between the process space and the intermediate space is inhibited by the separating wall. This vapor barrier is based on the pressure dependency of the length of the free path: at approximately normal pressure (700-1000 mbar), the diffusion through the comparatively small openings is inhibited. If, in contrast, the intermediate space is evacuated to pressures in the pre-vacuum range (10-1000 μbar), the free path length is greatly increased and the separating wall represents only a weak diffusion barrier for the gas exchange. The process space can be pumped out through the separating wall and after the pumping out through an inlet into the process box, process gas also flows into the process space. In particular, by means of the quasi-gas-tight separating wall, the partial pressure of readily volatile chalcogen components such as selenium or sulfur can be kept at least largely constant during the heat treatment in the process space.

In general, the process box according to the invention is implemented such that it can be opened or closed or assembled and (nondestructively) disassembled again for loading with a coated substrate and for removal of the processed substrate.

Multiple advantages can be obtained by means of the process box according to the invention. Thus, through the gas-tight implementation of the hollow space with at least one sealable gas passage that opens into the hollow space, evacuation of the process space is possible, in particular for pumping out corrosive process gases and reduction of the oxygen content and partial water pressure, as well as purging with inert gas and filling with process gas. Consequently, it is unnecessary to make locks and process stations for the heat treatment of the substrate gas-tight or evacuable such that the system is greatly simplified from a technical standpoint and the costs for its production and maintenance can be significantly reduced. Since corrosive process gases are present exclusively in the hollow space of the process box, increased wear of components of the system such as transport rollers for transport of the process box or radiant heaters for the heat treatment of the coated substrate can be avoided. In addition, moving parts can advantageously be dispensed with in the vacuum-compatible zone (process box) of the system. An evacuation of the hollow space of the process box can be accomplished quickly and efficiently. This applies equally for a filling with a process gas, wherein the process gas can be cost-effectively used in a minimum amount. The temperature control (active cooling) of at least one housing section of the process box enables a reduction in the wear, in particular of vacuum-compatible components of the process box during the heat treatment and, optionally, support of the active cooling of the coated substrate after the heat treatment. By means of the separating wall acting as a diffusion barrier or vapor barrier, condensation of volatile components, such as the chalcogen elements sulfur and selenium, generated during the heat treatment, on the temperature-controlled (actively cooled) housing section can be prevented in order to thus minimize the loss of volatile components in the process atmosphere and to keep their partial pressure in the process atmosphere at least largely constant. The consumption of volatile chalcogen elements can thus be minimized and the quality of the compound semiconductors produced can be improved. In addition, by means of the separating wall, the process space can be even further reduced compared to the hollow space of the process box. By means of the gas-tight process box, the substrate introduced into the process box is well protected against environmental influences. In a production system, the loaded process box can be transported between various process stations without having to remove the coated substrate from the process box. The process box can be selectively loaded with one or a plurality of coated substrates, whereby loading with a plurality of substrates can be preferred to increase the throughput.

As already mentioned, by means of the separating wall, a quasi-gas-tight division of the hollow space into a process space and an intermediate space is obtained, wherein the separating wall is provided for this purpose with one or a plurality of openings. Preferably, the separating wall is implemented such that during the heat treatment a loss in mass of a gaseous substance generated by the heat treatment of the coated substrate out of the process space is less than 50%, preferably less than 20%, more preferably less than 10%, of the mass of the gaseous substance generated during the heat treatment. Advantageously, the separating wall is implemented for this purpose such that an area ratio, formed from a (total) opening area of the one or a plurality of openings divided by an inner surface (interior area) of the process space, is in the range from 5×10⁻⁵ to 5×10⁻⁴. Thus, it can advantageously be achieved that the (total) opening area of the one or a plurality of openings of the separating wall is, on the one hand, adequately large to enable a rapid evacuation of the process space as well as a filling with process gas and is, on the other, adequately small such that the separating wall serves as an effective vapor barrier or diffusion barrier for volatile components generated in the process space during the heat treatment.

In a particularly advantageous embodiment of the process box, the separating wall contains or is made of a material that has such a coefficient of thermal expansion that a (total) opening area of the one or a plurality of openings is reduced by heating the separating wall during the heat treatment to a maximum of 50%, preferably a maximum of 30%, more preferably a maximum of 10%, of the starting value (total opening area before the heat treatment). Advantageously, for this purpose, the separating wall contains or is made of a material with a coefficient of thermal expansion of more than 5×10⁻⁶ K⁻¹. In this manner, a temperature-controlled separating wall is created with which, on the one hand, an especially efficient pumping out of the process space as well as filling of the process space with process gas is obtained in the cold state through a larger (total) opening area; on the other hand, an especially effective inhibition of the diffusion from the process space into the intermediate space of gaseous substances generated during the heat treatment is obtained in the warmer state during the heat treatment by thermal expansion through a smaller (total) opening area. In particular, the separating wall can be implemented such that during the heat treatment, the (total) opening area is reduced at least approximately to zero, such that a gas exchange between the process space and the intermediate space is almost completely suppressed during the heat treatment.

In an advantageous embodiment of the process box according to the invention, the housing of the process box comprises a base, a cover, as well as a frame connecting the base and the cover to one another. The base and the cover are realized, for example, in each case as plates, wherein the base and/or the cover are made of a material (e.g., glass ceramic) such that the coated substrate can be heat treated by the radiant energy of thermal radiation supplied on the underside of the base and/or the top side of the cover. The temperature-controllable (actively coolable) housing section is formed by at least one frame section. Also, the frame can be provided with the at least one sealable gas passage that opens into the hollow space in order to evacuate the hollow space and to selectively provide the process space with a specific gas atmosphere during specific process steps.

In the assembled state of the process box, the hollow space is implemented gas tight, while, for example, the cover can be implemented removable from the frame such that in a simple manner, the process space can be loaded with a coated substrate or the processed substrate can be removed. In a particularly advantageous embodiment of the process box, the frame comprises a first frame part fixedly connected to the base and a second frame part fixedly connected to the cover, with the two frame parts being gas-tightly joinable to each other to form the hollow space.

In an alternative embodiment to this, the process box comprises a housing with a one-piece housing section with a housing opening, which can be sealed by a preferably temperature-controllable (actively coolable) seal, for example, laterally. The separating wall is, for example, parallel to the seal.

In another advantageous embodiment of the invention, the housing section coupleable to a cooling device has a sealable gas passage that opens into the intermediate space (for example, through a valve), for removing/feeding at least one gaseous substance (e.g., evacuating and introducing process gas). Such a gas passage is, for example, provided with a gas connection, in particular a valve for controlling the gas flow. As a result of the cooling of the housing section, plastic seals customary in vacuum technology and other comparatively cost-effective standard components can be used for the vacuum sealing of the device. In particular, the cooled housing section with a gas passage is the seal for sealing the housing opening.

The invention further extends to an assembly for processing a coated substrate, with a process box implemented as described above, one or a plurality of radiant heaters for generating electromagnetic thermal radiation, which are arranged adjacent the at least housing section of the process box serving for the heat treatment, as well as a temperature controlling or cooling cooling device, which is thermotechnically coupled to the at least one temperature-controlable (actively coolable) housing section for its temperature control (active cooling).

In the above assembly, the radiant heaters are particularly advantageously arranged such that the intermediate space is situated at least partially, in particular completely, outside a common radiation field of the radiant heaters.

This measure makes it possible to set a temperature gradient (temperature barrier) between the separating wall and the temperature controlling (actively cooled) housing section of the process box. Preferably the temperature gradient is such that a pre-definable process temperature for the heat treatment of the coated substrate is obtained on the separating wall. For this purpose, the radiant heaters can, for example, be arranged exclusively above and/or below the process space.

Moreover, the invention extends to a method for processing a coated substrate in a transportable or stationary process box, which can, in particular, be implemented as described above.

The method comprises the following steps:
Introducing the coated substrate into a hollow space of the process box,
Gas-tight sealing of the hollow space of the process box,
Heat treating the coated substrate by electromagnetic thermal radiation, which is generated by radiant heaters arranged outside the process box and impinges on at least one housing section of the process box serving for the heat treatment, wherein during the heat treatment at least one gaseous substance is generated by the coated substrate,
Temperature controlling or cooling at least one housing section of the process box during and optionally after the heat treatment,
Inhibiting the diffusion of the gaseous substance generated during the heat treatment to the temperature-controlled or cooled housing section through a separating wall provided with one or a plurality of openings, which is arranged between the coated substrate and the temperature-controlled or cooled housing section.

In the method, the at least one section of the process box serving for the heat treatment, on which the thermal radiation impinges, is not temperature-controlled or cooled.

In an advantageous embodiment of the method, an intermediate space situated between the separating wall and the temperature-controlled or cooled housing section is at least partially, in particular completely, not irradiated by the electromagnetic thermal radiation.

In another advantageous embodiment of the method, a (total) opening area of the one or a plurality of openings of the separating wall is reduced during the heat treatment by heating the separating wall to a maximum of 50%, preferably a maximum of 30%, more preferably a maximum of 10%, of the starting value (total opening area before the heat treatment).

In another advantageous embodiment of the method, the hollow space of the process box is evacuated before and/or after the heat treatment of the coated substrate and/or filled with a process gas (at negative or positive pressure).

It is understood that the various embodiments of the invention can be realized individually or in any combinations. In particular, the above-mentioned characteristics and those to be explained below can be used not only in the combinations indicated but also in other combinations or in isolation without departing from the scope of the present invention.

### BRIEF DESCRIPTION OF THE DRAWINGS

The invention is now explained in detail with reference to the accompanying figures. They depict, in simplified representation not true to scale:

FIG. 1 a generalized cross-sectional representation of a process box according to the invention for processing a coated substrate;

FIG. 2 a perspective view of the process box of FIG. 1 with a front seal;

FIG. 3A-3C using various representations, an exemplary embodiment of the process box;

FIG. 4 a variant of the process box of FIG. 3A-3C with two joinable frame parts;

FIG. 5A-5F different variants of a temperature-controlled separating wall of the process box according to the invention.

The figures illustrate a process box horizontally oriented in a typical operating position. It is understood that the process box can also be oriented differently and that the position and direction indications made in the following description refer only to the representation of the process box in the figures, with this not to be construed as limiting the invention.

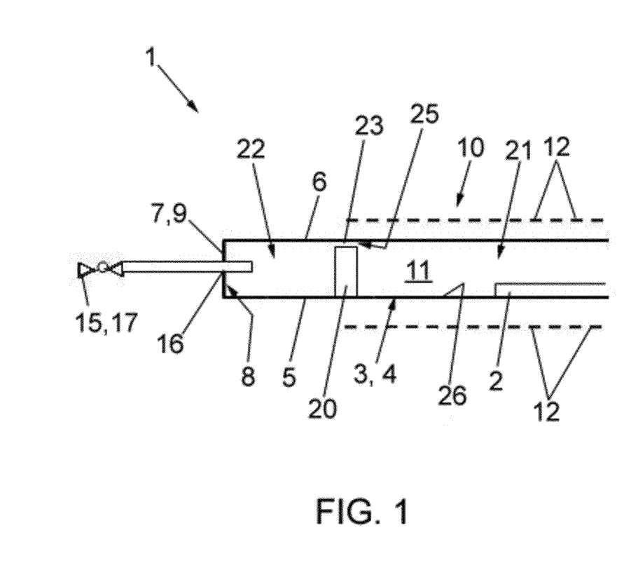

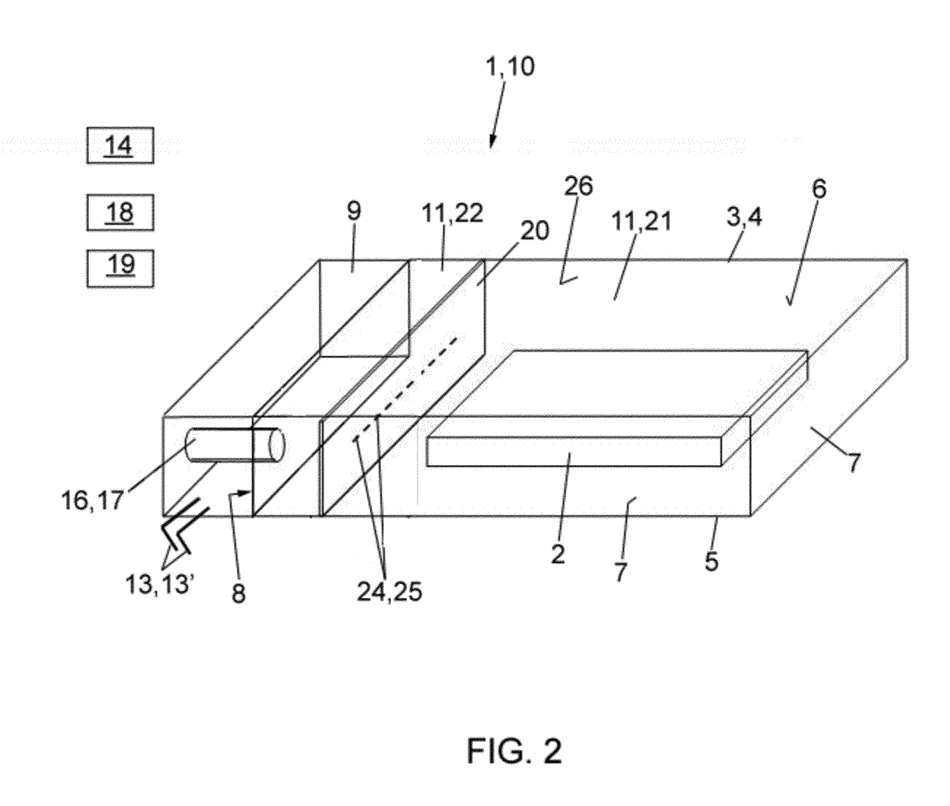

Reference is made first to FIGS. 1 and 2, in which a generalized sectional view of a process box 1 according to the invention for processing a coated substrate 2 (FIG. 1), as well as a perspective view of such a process box 1 with a front seal 9 (FIG. 2) is depicted. The process box 1 serves for processing a substrate 2 coated on one side, for example, for heat treating of precursor layers for conversion into a compound semiconductor, in particular, a chalcopyrite compound. Although only a single substrate 2 is depicted, the process box 1 could likewise be used for processing two or more substrates 2.

The process box 1 comprises here, for example, a rectangular-solid-shaped housing 3 with a housing wall 4, composed of a bottom wall 5, a top wall 6, and a peripheral side wall 7. The housing wall 4 encloses a gas-tight or evacuable hollow space 11, which is gas-tightly sealable by a removable seal 9. As depicted in FIG. 2, the housing 3 can, for example, have a front housing opening 8, which is sealable by a seal 9 mountable like a door, which forms a part of the side wall 7. Generally speaking, the housing opening 8 and the associated seal 9 can be selectively placed on any wall section of the housing wall 4. The bottom wall 5 serves in a central zone as a supporting surface for the substrate 2, with it being likewise possible also to provide corresponding spacers or support elements.

The housing wall 4 of the process box 1 can be made of the same material or from materials different from each other. Typical materials are metal, glass, ceramic, glass ceramic, carbon fiber reinforced carbon materials, or graphite. It is essential here that the top wall 6 and the bottom wall 5 are in each case implemented such that heat treatment of the coated substrate 2 by thermal energy fed in from the outside in the form of electromagnetic thermal radiation is possible. The thermal energy can be fed in in an assembly 10 schematically indicated in FIG. 1 by radiant heaters 12 arranged, for example, in rows above the top wall 6 as well as below the bottom wall 5. For example, the top wall 6 and the bottom wall 5 are made, for this purpose, from a material that is transparent or at least partially transparent to the electromagnetic radiation radiated in, for example, glass ceramic. The top wall 6 and the bottom wall 5 can also be made of such a material only in sections. It is also equally possible that the top wall 6 and the bottom wall 5 are made of a material that is suitable to at least partially, in particular completely, absorb the electromagnetic radiation in order to be heated themselves, for example, graphite. In this case, the top wall 6 and the bottom wall 5 serve as passively heated, secondary heat sources.

As is discernible in FIG. 2, the housing wall 4, here, for example, the seal 9, is provided with two coolant connections 13, 13′, which serve as an inlet or an outlet for coolant in a coolant line system (not shown in detail) running through the peripheral side wall 7 at least in sections, in particular completely. By means of the coolant introduced, the side wall 7 can be temperature controlled at least in sections to a pre-definable temperature or actively cooled relative to the substrate temperatures during the heat treatment. The two coolant connections 13, 13′ can be fluidically connected for this purpose to a temperature controlling device or cooling device 14 for preparation and cooling of the coolant. In general, in the process box, only those housing sections that do not serve for the heat treatment of the coated substrate 2 are temperature controlled or actively cooled, by thermal energy fed in from outside in the form of electromagnetic thermal radiation, here, for example, the peripheral side wall 7 or at least a section thereof. In the present example, only the seal 9 is temperature controlled or cooled. Oil or water, for example, can be used as coolant. The temperature control or active cooling can alternatively also be obtained through contact cooling (heat conduction) through contact with heat sinks (for example, cooling plates), a blower (convection cooling) or without contact by spaced heat sinks (radiative cooling).

The housing 3 further comprises a gas passage 16 provided with a valve 15 that opens into the hollow space 11. Here, the gas passage 16 is arranged, for example, in the front seal 9. The hollow space 11 can be evacuated via a gas connection 17 by connection to a pumping out device 18 (vacuum pump). Also, the gas connection 17 can be connected to a gas supply device 19 in order to purge the hollow space 11 by introduction of an inert purge gas and/or to fill it with a reactive process gas at negative or positive pressure. By means of the valve 15 (for example, a multipath valve), the gas passage 16 can be selectively opened or gas-tightly sealed. The hollow space 11 has a relatively low clear height, for example, in the range from 7 to 12 mm, in order to enable rapid evacuation and efficient filling with process gas.

The hollow space 11 is divided quasi-gas-tight by a strip-shaped separating wall 20 into a process space 21 and an intermediate space 22, with the coated substrate 2 accommodated only in the process space 21. The gas passage 16 opens into the intermediate space 22. The separating wall 20 is provided with one or a plurality of openings or breaks, by means of which the process space 21 is fluidically connected to the intermediate space 22.

As is discernible in the vertical sectional view of FIG. 1, the separating wall 20, which extends vertically from the bottom wall 5 in the direction of the top wall 6, does not reach all the way to the (interior side of the) top wall 6, such that a gap 23 remains as an opening of the separating wall 20. FIG. 2 depicts a variant in which the separating wall 20 extends all the way to the top wall 6 and is provided with a plurality of horizontal slots 24 arranged roughly centrally in a row. Through the gap 23 or the slots 24, the process space 21 is fluidically connected to the intermediate space 22 such that a mutual gas exchange is possible but is inhibited because of the small vertical dimension or height of the gap 23 or slots 24. The separating wall 20 thus acts as a diffusion barrier or a vapor barrier between the process space 21 and the intermediate space 22.

The property of the separating wall 20 to act as a diffusion barrier or a vapor barrier is based on the pressure dependency of free path length: at almost normal pressure (700-1000 mbar), the diffusion is inhibited by the relatively small opening(s) of the separating wall 20. In contrast, when the intermediate space 22 is evacuated to pressures in the pre-vacuum range (10-1000 μbar), the free path length is greatly increased and the separating wall 20 then represents only a weak diffusion barrier for the gas exchange. The process space 21 can thus be pumped out through the separating wall 20 and, after the pumping out, process gas can also flow into the process space 21 via an inlet into the intermediate space 22. On the other hand, by means of the separating wall 20, the partial pressure of readily volatile chalcogen components, such as selenium or sulfur, which diffuse/evaporate out of the coated substrate 2 during the heat treatment, can be kept at least largely constant in the process space 21 during the heat treatment of the substrate 2. The separating wall 20 thus acts, for example, as a selenium barrier during the heat treatment of a substrate 2.

Generally speaking, a (common) opening area 25 of the gap 23 or slots 24 is dimensioned such that, during the heat treatment of the substrate 2, a mass loss of a gaseous substance generated by the heat treatment of the coated substrate 2 out of the process space 21 is less than 50%, preferably less than 20%, more preferably less than 10%, of the mass of the gaseous substance generated in the process space 21 during the heat treatment. For this purpose, the separating wall 20 is implemented such that an area ratio, formed from the opening area 25 divided by an internal surface or inner surface 26 of the process space 21, is in the range from 5×10⁻⁵ to 5×10⁻⁴.

For example, the inner surface 26 of the process space 21 has a size of ca. 1.2 m². A mean gap height of the gap 23 is, for example, in the range from 50 to 100 μm, corresponding to an opening area 25 in the range from 2 to 5 cm². The separating wall 20 has, for example, a height of von 9 mm. These values yield an area ratio of 1.5×10⁻⁴.

By means of the separating wall 20 serving as a vapor barrier or diffusion barrier, a diffusion of volatile components developing in the process space 21 during the heat treatment into the intermediate space 22 can at least be largely suppressed such that a condensation of the volatile components on the temperature-controlled (actively cooled) side wall 7, here, specifically the seal 9, is prevented. The process atmosphere in the process space 21 can thus be kept at least approximately constant.

As illustrated in FIG. 2, the intermediate space 22 is situated at least partially, in particular completely, outside a (common) radiation field of the radiant heaters 12 such that during the heat treatment, a temperature gradient is formed in the intermediate space 22 from the separating wall 20 to the temperature-controlled (actively cooled) side wall 7, here, specifically the seal 9. This temperature gradient serves as a “temperature barrier” for protection of vacuum-compatible components of the process box 1 against high thermal stress. For this purpose, the radiant heaters 12 are arranged exclusively above or below the process space 21 in front of or up to the separating wall 20. The radiant heaters 12 end in each case at least a few centimeters in front of the intermediate space 22 or separating wall 20. On the other hand, the radiant heaters 12 are arranged such that a rising temperature gradient is formed such that a desired process temperature for the heat treatment of the coated substrate 2 is obtained starting from the side wall 7, specifically seal 9, to the separating wall 20 in front of or at least at the level of the separating wall 20 in order to ensure an adequate conversion of the precursor layers of the substrate 2 into compound semiconductors.

In the general embodiment illustrated in FIG. 1, the separating wall 20, the intermediate space 22, and the temperature-controllable or coolable section(s) of the side wall 7 can be designed laterally in one direction, in two directions, or peripherally (frame). In the embodiment of FIG. 2, the separating wall 20, the intermediate space 22, and the temperature-controllable section of the side wall 7 (seal 9) are realized only in one spatial direction.

The substrate 2 is made, for example, of glass with a thickness in the range from 1 mm to 4 mm, in particular 2 mm to 3 mm. The substrate 2 is provided with a layer structure (not shown in detail), which consists, for example, of precursor layers of an absorber (e.g., chalcopyrite compound or kesterite compound), which must be subjected to RTP thermal processing. For example, the layer structure is a sequence of the layers silicon nitride/molybdenum/copper-indium-gallium/selenium. For example, the silicon nitride layer has a thickness in the range from 50 nm to 300 nm; the molybdenum layer, a thickness in the range from 200 nm to 700 nm; the copper-indium-gallium layer, a thickness in the range from 300 nm to 1000 nm; and the selenium layer, a thickness in the range from 500 nm to 2000 nm.

The process box 1 can be assembled simply using automation and loaded or unloaded through the housing opening 8. The separating wall 20 must be moved in each case during opening and closing such that the substrate 2 can be brought into it.

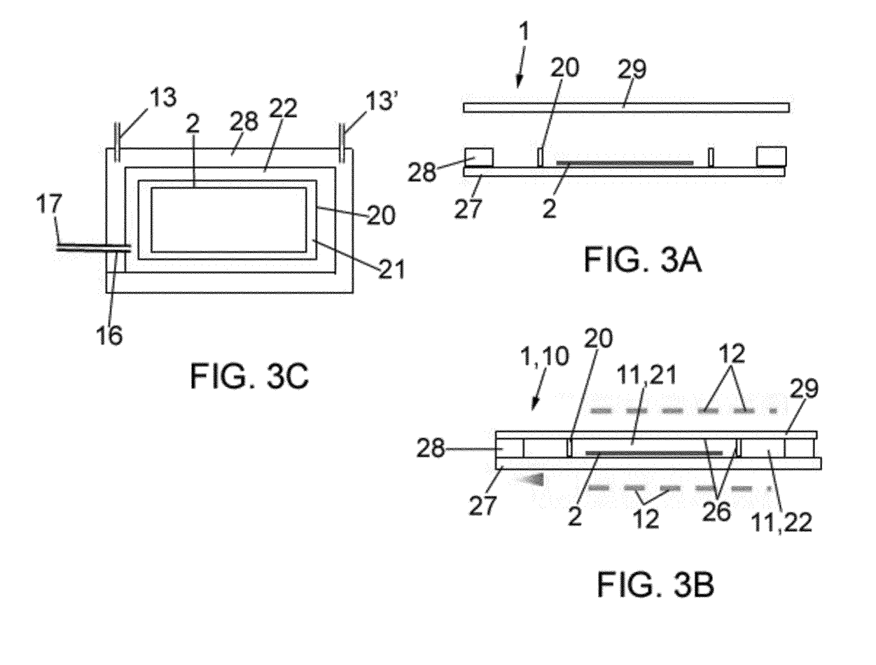

Referring to FIG. 3A-3C, another exemplary embodiment of the process box 1 illustrated generally in FIG. 1 is described with reference to various representations.

Accordingly, the process box 1 comprises a base plate 27, on which, in an edge region, a peripherally closed frame 28 is placed loosely, but sealably. It would be conceivable to fixedly connect the frame 28 to the base plate 27. As can be readily discerned in the vertical sectional representations of FIGS. 3A and 3B, the base plate 27 serves in a central zone as a support for the substrate 2, with it being equally possible to provide corresponding spacers or support elements. A flat cover plate 29 is placed loosely on the frame 28. By removal of the cover plate 29 from the frame 28, the process box 1 can be loaded in a simple manner, in particular using automation, with the coated substrate 2 or the processed substrate 2 can be removed. FIG. 3A depicts the open process box 1 with the cover plate 29 raised; FIG. 3B, the closed process box 1 with the cover plate 29 in place on the frame 28.

In the process box 1, baseplate 27, frame 28, and cover plate 29 are arranged above and below each other in the form of a stack and together enclose the gas-tight or evacuable hollow space 11. The hollow space 11 is divided quasi-gas-tight by the strip-shaped separating wall 20 implemented peripherally closed in correspondence with the frame 28 into the (inner) process space 21 and the peripheral (outer) intermediate space 22. The intermediate space 22 surrounds the process space 21. Analogously to FIG. 1, the strip-shaped separating wall 20 extends vertically from the baseplate 27 in the direction toward the cover plate 29, wherein a narrow gap 23 remains between the separating wall 20 and the cover plate 29. By means of the gap 23, the process space 21 is fluidically connected to the intermediate space 22 such that a mutual gas exchange is possible, with the separating wall 20, however, acting as a diffusion barrier or vapor barrier. Reference is made to the statements concerning this with regard to FIG. 1.

As is discernible in FIG. 3C, the gas passage 16 provided with the valve 15 opens through the frame 28 into the intermediate space 22, in order to evacuate the hollow space 11, to purge it with an inert purge gas (e.g., N₂), and to fill it with a process gas. The process gas introduced through the gas passage 16 can, for example, contain reactive gases, such as H₂S, H₂Se, S vapor, Se vapor, or H₂ as well as inert gases such as N₂, He, or Ar.

As is further discernible in FIG. 3C, the frame 28 is provided with the two coolant connections 13, 13′, which serve as an inlet or an outlet for coolant in a coolant line system (not shown in detail) extensively running through the frame 28. By means of the coolant introduced into the frame 28, the frame 28 can be temperature controlled (actively cooled) during and, if desired, after the heat treatment of the substrate 2. The two coolant connections 13, 13′ are fluidically connected for this purpose to the cooling device 14 for the preparation and cooling of the coolant. The frame 28 is preferably made of a material with high thermal conductivity, for example, a metal material, in particular, stainless steel.

The baseplate 27 and the cover plate 29 are in each case implemented such that heat treatment of the coated substrate 2 by thermal energy fed above or below the process box 1 in the form of electromagnetic thermal radiation is possible. Reference is made to the statements concerning this with regard to FIG. 1. For this purpose, the baseplate 27 and the cover plate 29 are made, for example, of glass ceramic.

Through the separating wall 20 serving as a vapor barrier or a diffusion barrier, diffusion of volatile components developing in the process space 21 during the heat treatment can be, at least largely suppressed such that condensation of the volatile components on the temperature-controlled (actively cooled) frame 28 is prevented. The process atmosphere in the process space 21 can thus be kept at least approximately constant.

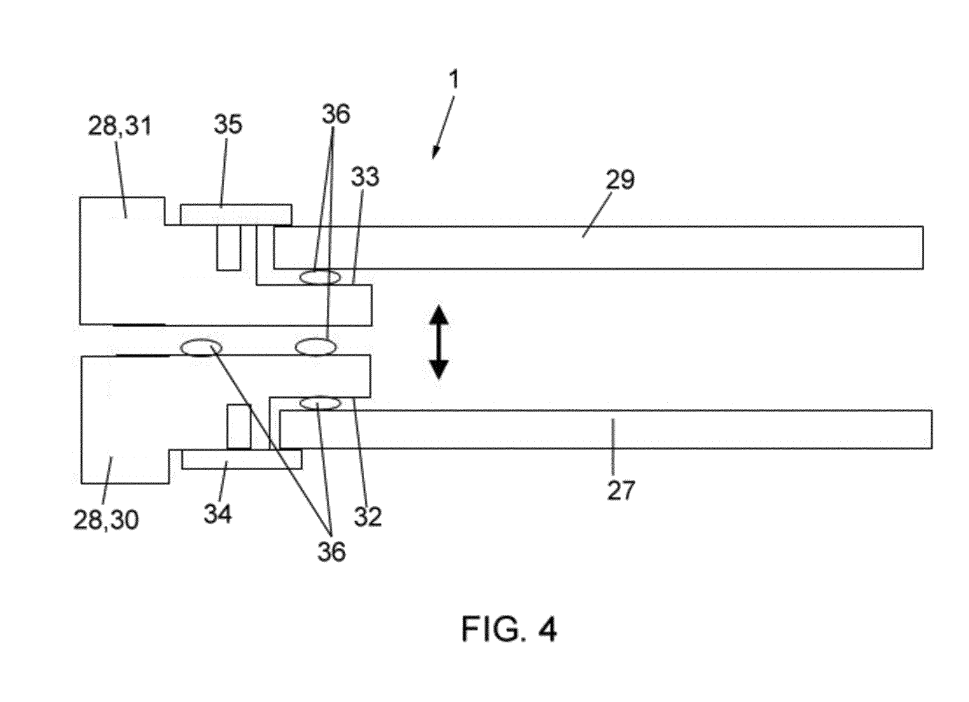

FIG. 4 depicts a variant of the process box 1 of FIG. 3A-3C. To avoid unnecessary repetitions, only the differences relative to FIG. 3A-3C are depicted and, otherwise, reference is made to the statements concerning this. Accordingly, the process box 1 differs in that the frame 28 consists of two frame parts 30, 31 that can be gas-tightly joined to each other. Thus, a lower, first frame part 30 is provided, which has a first bearing surface 32, against which the baseplate 27 is clamped for fixed connection by a first clamping member 34. Analogously, an upper, second frame part 31 is provided, which has a second bearing surface 33, against which the cover plate 29 is clamped for fixed connection by a second clamping member 35. As indicated by the double arrow, the second frame part 31 can be lifted from the first frame part 30, in order to load the process box 1 with the substrate 2 or to remove the processed substrate 2. On the other hand, the two frame parts 30, 31 can be gas-tightly joined, with the required gas-tightness ensured by sealing members 36. The process box 1 is distinguished by especially simple automatable loadability and unloadability.

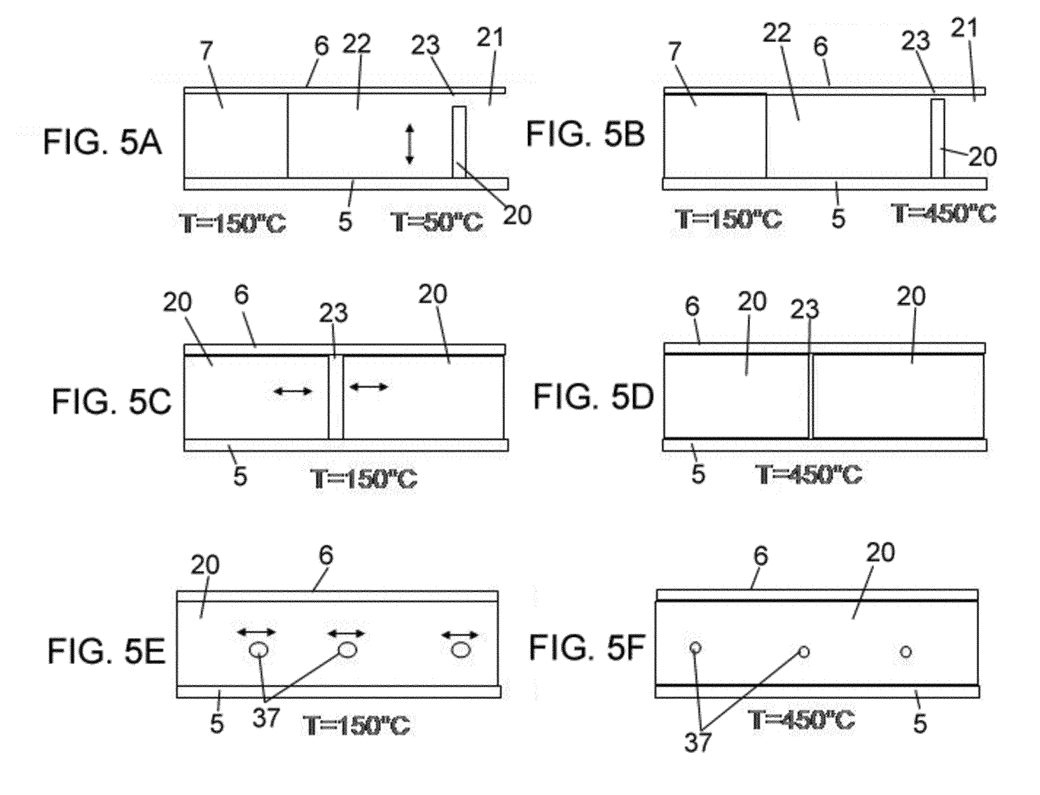

Reference is now made to FIG. 5A-5F, in which different variants of the separating wall 20 of the process box 1 are illustrated. This is in each case a temperature-controlled separating wall 20, which is, for this purpose, made of a material that has a coefficient of thermal expansion such that a total opening area 25 of the respective openings or breaks is reduced by heating the separating wall 20 during the heat treatment to a maximum of 50%, preferably a maximum of 30%, more preferably a maximum of 10%, of the starting value (total opening area 25 before the thermal processing). The separating wall 20 is made, for this purpose, of a material with a coefficient of thermal expansion of more than 5×10⁻⁶ K⁻¹. Examples for this are certain glass ceramics with a coefficient of thermal expansion of 9×10⁻⁶ K⁻¹, aluminum oxide (Al₂O₃) with a coefficient of thermal expansion in the range from 6.5×10⁻⁶ K⁻¹ to 9×10⁻⁶ K⁻¹, zirconium oxide and magnesium oxide with a coefficient of thermal expansion in the range from 10×10⁻⁶ K⁻¹ to 13×10⁻⁶ K⁻¹. The material of the separating wall 20 must also be temperature resistant and corrosion resistant.

FIGS. 5A and 5B depict the separating wall 20 of the process box 1 implemented as a vertical strip, in each case in a vertical sectional representation. Accordingly, the separating wall 20 does not extend all the way to the top wall 6 or the cover plate 29 such that the gap 23 remains as an opening for the fluidic connection of the process space 21 and the intermediate space 22. FIG. 5A depicts a situation in which the side wall 7 or the frame 28 is temperature controlled to a temperature of T=150 ° C., whereas the separating wall 20 has a temperature of T=50° C. The material of the separating wall 20 is relatively cold; the gap 23 is wide open. The vertical dimension or mean gap height (clear width) of the gap 23 is in the range from 50 to 100 μm with a height of the separating wall 20 of ca. 10 mm. During heating, the material of the separating wall 20 expands relatively dramatically, with the mean gap height decreasing (FIG. 5B). For example, with heating of the separating wall 20 to a temperature of T=450° C. (temperature difference 400° C.), a change in the vertical dimension of the separating wall 20 of ca. 40 μm is attained such that the mean gap height of the gap 23 decreases to a value in the range from 10 to 50 μm, i.e., a maximum of 50% of the starting value.

FIGS. 5C and 5D depict a variant with reference to a view of the separating wall 20. To avoid unnecessary repetitions, only the differences relative to FIGS. 5A and 5B are explained, and, otherwise, reference is made to the statements there. Accordingly, the strip-shaped separating wall 20 extends from the bottom wall 5 or the baseplate 27 to the top wall 6 or the cover plate 29, with one or a plurality of vertical gaps 23 implemented in the form of breaks of the separating wall 20. The gap width measured in the horizontal direction is in the range from 50 to 100 μm (FIG. 5C). By means of a dimensioning of the separating wall regions between two gaps 23 greater compared to the height of 10 m, relatively greater travel, which can, for example, amount to several 100 μm, can be obtained with heating of the separating wall 20 to a temperature of, for example, T=450° C. In particular, the total opening area of the gaps 23 can be reduced to, for example, a maximum of 50% of the starting value.

FIGS. 5E and 5F depict another variant with reference to a view of the separating wall 20. To avoid unnecessary repetitions, again only the differences relative to FIGS. 5A and 5B are explained, and, otherwise, reference is made to the statements there. Accordingly, a plurality of round holes 37 are provided instead of a gap 23, which are in each case implemented in the form of perforations of the separating wall 20. Starting from a situation in which the temperature of the separating wall 20 is, for example, T=150° C. (FIG. 5E), a reduction of the diameter of the opening of the round holes 37 can be obtained by heating the separating wall 20 to a temperature of, for example, T=450° C. (FIG. 5F). In particular, the entire opening area of the round holes 37 can be reduced to, for example, a maximum of 50% of the starting value.

The process box according to the invention 1 enables processing of substrates 2 in a system, in which the process stations need not be implemented as vacuum-compatible chambers such that the investment costs are significantly reduced. In addition, increased wear of system components due to high temperatures and corrosive gases can be avoided. In the process box 1, conversion of precursor materials into absorbers can occur in a controlled manner during RTP thermal processing. The process box 1 supports the production of coated substrates 2 for thin-film solar modules with high quality requirements.

### LIST OF REFERENCE CHARACTERS

1 process box
2 substrate
3 housing
4 housing wall
5 bottom wall
6 top wall
7 side wall
8 housing opening
9 seal
10 assembly
11 hollow space
12 radiant heaters
13, 13′ coolant connection
14 cooling device
15 valve
16 gas passage
17 gas connection
18 pumping-out device
19 gas supply device
20 separating wall
21 process space
22 intermediate space
23 gap
24 slot
25 opening area
26 inner surface
27 baseplate
28 frame
29 cover plate
30 first frame part
31 second frame part
32 first bearing surface
33 second bearing surface
34 first clamping member
35 second clamping member
36 sealing member
37 round hole

1. Process box for processing a coated substrate, comprising:
a gas-tightly sealable housing, which encloses a hollow space,
the housing comprises at least one housing section, which is implemented such that the substrate is heat treatable by incident electromagnetic thermal radiation,
the housing has at least one housing section coupleable to a cooling device for its cooling,
the hollow space is divided by at least one separating wall into a process space for accommodating the substrate and an intermediate space, wherein the separating wall has one or a plurality of openings and is arranged between the substrate and the housing section coupleable to the cooling device,
the housing is provided with at least one sealable gas passage opening into the hollow space for evacuating and introducing process gas into the hollow space.

2. Process box according to claim 1, wherein the separating wall is implemented such that during the heat treatment a mass loss of the gaseous substance generated by the heat treatment of the coated substrate out of the process space is less than 50%, preferably less than 20%, more preferably less than 10%, wherein the separating wall is implemented such that an area ratio, formed from a total opening area of the one or a plurality of openings divided by an inner surface of the process space, is in the range from 5×10⁻⁵ to 5×10⁻⁴.

3. Process box according to claim 1, wherein the separating wall contains a material, which has such a coefficient of thermal expansion, that a total opening area of the one or a plurality of openings is reduced by heating the separating wall during the heat treatment to a maximum of 50% of a total opening area before the heat treatment.

4. Process box according to claim 1, wherein the separating wall contains a material with a coefficient of thermal expansion of more than 5×10⁻⁶K⁻¹.

5. Process box according to claim 1, wherein the housing comprises a bottom, a cover, as well as a frame connecting a bottom and a cover to each other, wherein the housing section coupleable to a cooling device is formed by at least one frame section.

6. Process box according to claim 5, wherein the frame comprises a first frame part fixedly connected to the bottom and a second frame part fixedly connected to the cover, wherein the two frame parts are gas-tightly joinable to each other to form the hollow space.

7. Process box according to claim 1, wherein the housing comprises:
a one-piece housing section, which encloses the hollow space, with a housing opening,
a seal for the gas-tight sealing of the housing opening.

8. Process box according to claim 7, wherein the housing section coupleable to a cooling device includes the seal.

9. Assembly for processing a coated substrate comprising:
a process box according to claim 1,
one or a plurality of radiant heaters for generating electromagnetic thermal radiation, which are arranged adjacent the at least one housing section of the process box serving for the heat treatment,
a cooling device, which is coupled to at least one housing section for its cooling.

10. Assembly according to claim 9, wherein the radiant heaters are arranged such that the intermediate space is situated at least partially outside a common radiation field of the radiant heaters.

11. Assembly according to claim 10, wherein the radiant heaters are arranged exclusively above and/or below the process space.

12. Method for processing a coated substrate in a transportable or stationary process box the method comprising:
introducing the coated substrate into a hollow space of the process box,
gas-tight sealing of the hollow space of the process box,
heat treating the coated substrate by electromagnetic thermal radiation, which is generated by radiant heaters arranged outside the process box and impinges on at least one housing section of the process box serving for the heat treatment, wherein during the heat treatment at least one gaseous substance is generated by the coated substrate,
cooling at least one housing section of the process box during and optionally after the heat treatment,
inhibiting the diffusion of the gaseous substance generated during the heat treatment to the cooled housing section through a separating wall provided with one or a plurality of openings, which is arranged between the coated substrate and the cooled housing section.

13. Method according to claim 12, wherein an intermediate space situated between the separating wall separating wall and the cooled housing section is at least partially not irradiated by the electromagnetic thermal radiation.

14. Method according to claim 12, wherein a total opening area of the one or a plurality of openings of the separating wall is reduced during the heat treatment by heating the separating wall to the maximum of 50% of the starting value before the heat treatment.

15. Method according to claim 12, wherein the hollow space of the process box is evacuated before and/or after the heat treatment of the coated substrate and/or filled with a process gas.

16. Process box according to claim 1, wherein the separating wall contains a material, which has such a coefficient of thermal expansion, that a total opening area of the one or a plurality of openings is reduced by heating the separating wall during the heat treatment to a maximum of 30% of a total opening area before the heat treatment.

17. Process box according to claim 1, wherein the separating wall contains a material, which has such a coefficient of thermal expansion, that a total opening area of the one or a plurality of openings is reduced by heating the separating wall during the heat treatment to a maximum of 10% of a total opening area before the heat treatment.

18. Assembly according to claim 9, wherein the radiant heaters are arranged such that the intermediate space is situated completely outside a common radiation field of the radiant heaters.

19. Method according to claim 12, wherein an intermediate space situated between the separating wall separating wall and the cooled housing section is completely not irradiated by the electromagnetic thermal radiation.

20. Method according to claim 12, wherein a total opening area of the one or a plurality of openings of the separating wall is reduced during the heat treatment by heating the separating wall to the maximum of 30% of the starting value before the heat treatment.
